(19) United States
(12) Patent Application Publication
(10) Pub. No.: US 2007/0218171 A1
(43) Pub. Date: Sep. 20, 2007

(54) Frozen pet novelties

(76) Inventors: Hannah Elizabeth Mehrle, Hamilton, OH (US); Amy Clare Mehrle, Hamilton, OH (US); Noah Joseph Mehrle, Hamilton, OH (US); Sarah Elizabeth Mehrle, Hamilton, OH (US)

Correspondence Address: Amy Mehrle, 4617 Peakview Court, Hamilton, OH, 45011, US

(21) Appl. No.: 11/384,698

(22) Filed: Mar. 20, 2006

(51) Int. Cl. A23G 3/20

(52) U.S. Cl. 426/100

(57) ABSTRACT

Frozen pet novelties are provided. A first frozen pet consumable portion surrounds at least one end of a supporting pet consumable portion that supports the first frozen pet consumable portion.

### FIELD

The invention relates generally to frozen novelties and more particularly to frozen pet novelties.

### BACKGROUND

Pets have become important social members in the families and lives of their human counterparts. Pet owners are even concerned with the safety and well being of their pets. Pet owners may even have funerals and bury their pets. In some cases, pet owners have even attempted to legally bequeath property to pets upon the passing of the pet owners.

There is little doubt that for a large portion of society pets have become vital social members. No where is this more apparent then in the marketplace where products and devices abound for pets. In fact the market for pet related products has reached tens of billions of dollars. Companies have taken notice and have aggressively marketed and developed entire product lines for pets and their owners.

### SUMMARY

In various embodiments, a frozen pet novelty is provided. In an embodiment, a frozen pet novelty includes a frozen pet consumable portion and a cylindrical pet consumable portion. The cylindrical pet consumable portion is at least partially integrated into an inside portion of the frozen pet consumable portion and it supports the frozen pet consumable portion on one end of the cylindrical pet consumable portion.

### BRIEF DESCRIPTION OF THE DRAWINGS

FIG. 1A-1B are diagrams of a frozen pet novelty, according to an example embodiment.

FIG. 2 is a diagram of method for producing a frozen pet novelty, such as the frozen pet novelty of the FIG. 1, according to an example embodiment.

FIG. 3 is a diagram of a frozen pet novelty system, according to an example embodiment.

FIGS. 4A-4D are diagrams of example frozen pet novelties, according to example embodiments.

### DETAILED DESCRIPTION

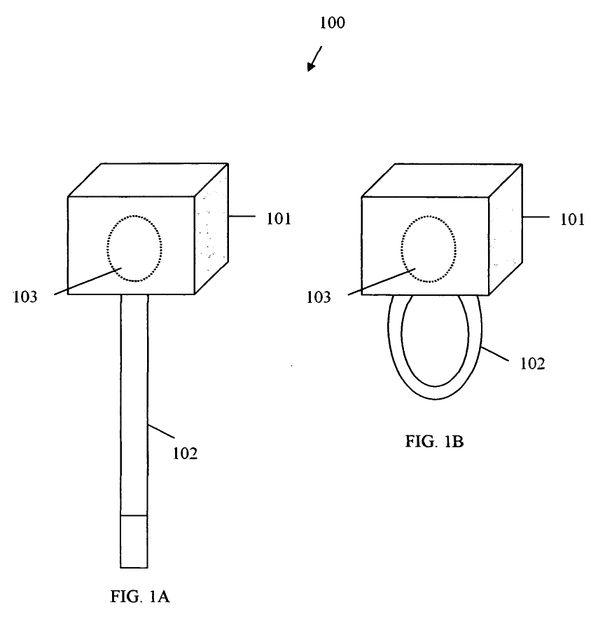

FIG. 1A is a diagram of a frozen pet novelty 100, according to an example embodiment. The frozen pet novelty 100 includes a first frozen pet consumable portion 101 and a cylindrical pet consumable portion 102. In some embodiments, the frozen pet novelty 100 may also include a pet food treat 103. Each of these components of the frozen pet novelty 100 will now be discussed in turn.

The first frozen pet consumable portion 101 includes a mixture of frozen liquid and other components. The mixture may include, by way of example, beef bouillon, chicken bouillon, ground chunks of pieces of meat, flavored gravy, ground chunks of pet food, such as dog food or cat food, and the like. The liquid may be water, flavored juices, flavored beverages, etc. It is also noted that various combinations of the ingredients may be used in forming the mixture.

The mixture is frozen in a mold to form a shape for the first frozen pet consumable portion 101 and it is frozen to surround and adhere to the cylindrical pet consumable portion 102 on at least one end of the cylindrical pet consumable portion 102. The shape of the first frozen pet consumable portion 101 may be in a variety of configurable or desired shapes. In some cases, the shape is visually appealing to a pet, such as in the shape of a ball, a cat, a bird, etc.

According to an embodiment, the first frozen pet consumable portion 101 also includes an integrated pet food treat 103 suspended within the center of the first frozen pet consumable portion 101. For example, the pet food treat 103 is frozen within the mold such that it is visible within the first frozen pet consumable portion 101. Any desired pet food treat 103 may be suspended within the first frozen pet consumable portion 101.

The cylindrical pet consumable portion 102 supports the first frozen pet consumable portion 101 and has at least one end included within the mold and the mixture before it is frozen. This adheres the cylindrical pet consumable portion 102 on at least one end to the first frozen pet consumable portion 101 and produces a frozen pet novelty 100.

The cylindrical pet consumable portion 102 may include a variety of solid edible pet substances, such as but not limited to, rawhide, meat jerky, and the like.

Additionally, the cylindrical pet consumable portion 102 may be integrated within the first frozen pet consumable portion 101 on two of its ends, also shown as an alternative arrangement in FIG. 1B. In this case, the cylindrical pet consumable portion 102 forms a handle that a pet owner may use to hold or grasp the cylindrical pet consumable portion 102 while the pet consumes the first frozen pet consumable portion 101; after the first frozen pet consumable portion is consumed the cylindrical pet consumable portion 102 may be released for the pet to consume as well.

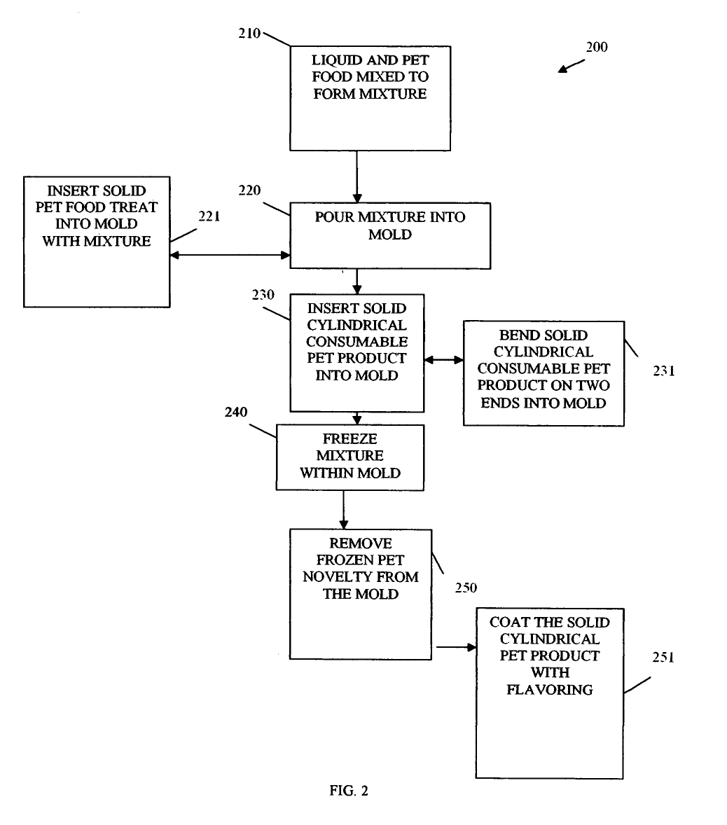

FIG. 2 is a diagram of method 200 for producing a frozen pet novelty, such as the frozen pet novelty 100 of the FIG. 1, according to an example embodiment. The method 200 may be implemented using a variety of apparatuses and fabrication processes commercialized or non commercialized.

At 210, a liquid and a pet food product is mixed together to form a mixture. The pet food product may itself be a mixture or a solid food product substance. That is, the pet food product may include ground meat, liquid meat flavoring, and the like. For health conscious pet owners the pet food product may include vitamins and/or minerals; it may also be produced in low calorie or low fat versions. In some cases, the pet food product may include medicine prescribed by a veterinarian. The texture and visual (color) appearance may also be customized and/or a variety of fillers added.

The liquid may include water, beverages, juices, or various combinations of the same. In some cases, the liquid is a clear liquid. The liquid and the pet food product are combined or mixed to form the mixture.

At 220, the mixture is poured into a mold. The mold is used to house the mixture in its liquid state during the freezing process. The mold also supplies a mechanism to achieve a variety of desired shapes for the resulting frozen pet novelty.

According to an embodiment, at 221, an additional solid pet food treat may be integrated into the mold and surrounded by the mixture. In cases where the mixture is a clear or semi clear, the solid pet food treat may be visible through the frozen version of the mixture.

At 230, the solid cylindrical consumable pet product is inserted into the mold with the mixture, and if appropriate the solid pet food treat. That is, at least one end of the solid cylindrical consumable pet product is surrounded by the mixture and is suspended within the mold in the approximate center of the mixture within the mold. The remaining portion of the solid cylindrical consumable pet product extends outside the mold and when the mixture is frozen may be used to support the frozen mixture as a frozen pet novelty.

In an embodiment, at 231, the solid cylindrical consumable pet product may be bent such that the opposing end of the solid cylindrical consumable pet product is also inserted into the mold. This forms a hole and a handle that may be used to grasp and hold the frozen pet novelty once completed.

At 240, the mold with the mixture and the solid cylindrical consumable pet product and perhaps the pet food treat are frozen or subjected to temperatures below freezing until the mixture becomes a solid.

At 250, the mixture that is adhered to the solid cylindrical consumable pet product in a solid state is removed from the mold. This independent apparatus is now a frozen pet novelty, which may be given to a pet for consumption.

In some embodiments, at 251, the solid cylindrical consumable pet product may also be coated with an additional flavoring appealing to a pet for which the frozen pet novelty is being produced. It is noted, that the solid cylindrical consumable pet product may be coated before it is inserted into the mold or may come prefabricated with a edible coating. Alternatively, it may be dipped or sprayed with the coating after the frozen novelty is produced.

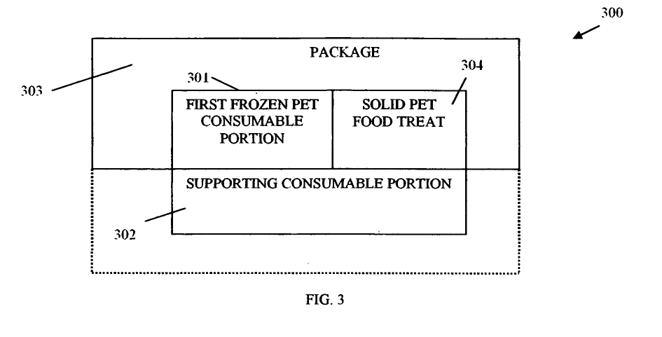

FIG. 3 is a diagram of a frozen pet novelty system 300, according to an example embodiment. The frozen pet novelty system 300 includes a frozen pet novelty, such as the frozen pet novelty 100 of the FIG. 1 and produced by the method 200 of the FIG. 2. The frozen pet novelty system 300 also includes an additional component to package and house the frozen pet novelty 100.

Accordingly, the frozen pet novelty system 300 includes a first frozen pet consumable portion 301, a supporting pet consumable portion 302, and a package 303. In an embodiment, the frozen pet novelty system 300 may also include a solid pet food treat 304.

The supporting pet consumable portion 302 is integrated on at least one end into the first frozen pet consumable portion 301 and supports the first frozen pet consumable portion 301. The first frozen pet consumable portion 301 and the supporting pet consumable portion 302 combine to form the frozen pet novelty, such as the frozen pet novelty 100 of the FIG. 1.

According to an embodiment, the resulting frozen pet novelty may also include a solid pet food treat 304 suspended and integrated within the first frozen pet consumable portion 301. This arrangement was discussed above with respect to the frozen pet novelty 100 of the FIG. 1.

The package 303 is to house the first frozen pet consumable portion 301, which is integrated with the supporting pet consumable portion 302, and optionally the solid pet food treat 304. The package 303 may be a wrapper of sorts that surrounds the first frozen pet consumable potion 301 but not all of the supporting pet consumable portion 302. In another case, the package 303 is large enough to house a plurality of frozen pet novelties. So, the package 303 may be customized for a single frozen pet novelty or some configurable and desired grouping of a plurality of frozen pet novelties.

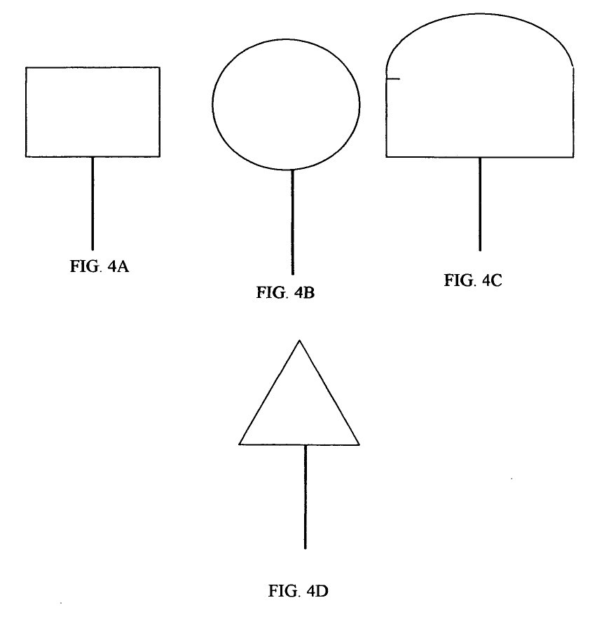

The shapes of the first frozen pet consumable portion 301 and the supporting pet consumable portion 302 and dimensions are configurable as well. The shapes of each may be spherical, block, or cubic, or in custom shapes. A variety of sample configurations are shown in FIGS. 4A-4D.

One now appreciates how a frozen pet novelty that is entirely consumable may be produced and packaged. The frozen pet novelty may be customized for a particular pet, such as but not limited to a dog, a cat, a rabbit, a horse, etc. The edible and consumable pet product may include substances and materials appealing to the pet for which it is made and may include beneficial substances.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A frozen pet novelty, comprising:
a frozen pet consumable portion; and
a cylindrical pet consumable portion that is at least partially integrated into an inside portion of the frozen pet consumable portion and that supports the frozen pet consumable portion on one end of the cylindrical pet consumable portion.

2. The frozen pet novelty of claim 1, wherein the cylindrical pet consumable portion is at least one of a rawhide material and a dried meat jerky material.

3. The frozen pet novelty of claim 1, wherein the frozen pet consumable portion includes a mixture of frozen water and at least one of chicken flavored bouillon, beef flavored bouillon, and flavored gravy.

4. The frozen pet novelty of claim 1, wherein the frozen pet consumable portion includes a mixture of frozen water and at least one of ground pieces of meat and ground pieces of pet food.

5. The frozen pet novelty of claim 1, wherein the cylindrical pet consumable portion includes a pet flavored coating on an outer surface of the cylindrical pet consumable.

6. The frozen pet novelty of claim 1, wherein the frozen pet consumable portion is in a shape that is visually appealing to a pet.

7. The frozen pet novelty of claim 1, wherein a second end of the cylindrical pet consumable is also integrated into the inside portion of the frozen pet consumable portion, and where the cylindrical pet consumable is shaped as a handle.

8. The frozen pet novelty of claim 1 further comprising, a solid pet food treat suspended within the frozen pet consumable portion.

9. The frozen pet novelty of claim 8, wherein the frozen pet consumable portion is a clear liquid mixture and the solid pet food treat is visible within the frozen pet consumable portion.

10. A method, comprising:
mixing a pet food product with a liquid to form a mixture;
pouring the mixture into a mold;
inserting a solid cylindrical consumable pet product into the mold with the mixture surrounding at least one end of the solid cylindrical pet consumable product;
freezing the mixture; and
removing the mold to release a frozen pet novelty.

11. The method of claim 10 further comprising, inserting a solid pet food treat within the mold surrounded by the mixture before it is frozen and locating the solid pet food treat adjacent to the at least one end of the solid cylindrical pet consumable product.

12. The method of claim 10 further comprising, coating a portion of the solid cylindrical pet consumable product not surrounded by the mixture in a pet flavored coating.

13. The method of claim 10, wherein inserting further includes bending the solid cylindrical pet consumable product and inserting two ends into the mold and forming a handle to hold the frozen pet novelty.

14. A system, comprising,
a first frozen pet consumable portion;
a supporting pet consumable portion integrated on at least one end into the first frozen pet consumable portion and supporting the first frozen pet consumable portion; and
a package that is to house the first frozen pet consumable portion integrated with the supporting pet consumable portion.

15. The system of claim 14, wherein the package is to house a plurality of additional frozen pet consumable portions integrated with a plurality of additional supporting pet consumable portions.

16. The system of claim 14, wherein a non integrated end of the supporting pet consumable portion extends at least partially outside of the package.

17. The system of claim 14 further comprising, a pet food treat suspended within the first frozen pet consumable portion.

18. The system of claim 14, wherein the package is a wrapper that surrounds the first frozen pet consumable portion and surrounds the at least one end of the supporting pet consumable portion.

19. The system of claim 14, wherein the supporting pet consumable portion is in a shape of at least one of a cylinder and a block.

20. The system of claim 19, wherein the first frozen pet consumable portion is in a shape of at least one of a sphere and a block.
